(19) United States
(12) Patent Application Publication
(10) Pub. No.: US 2012/0250354 A1
(43) Pub. Date: Oct. 4, 2012

(54) Illuminator for Display and Display

(75) Inventor: Kenji YOSHIDA, Daito-shi (JP)

(73) Assignee: Funai Electric Co., Ltd., Daito-shi (JP)

(21) Appl. No.: 13/401,155

(22) Filed: Feb. 21, 2012

(30) Foreign Application Priority Data
Mar. 29, 2011 (JP) 2011-72953

(51) Int. Cl. F21V 8/00

(52) U.S. Cl. 362/613; 362/611

(57) ABSTRACT

This backlight (illuminator for a display) includes a substrate having a mounting surface mounted with an LED, a light guide plate including a light guide plate body portion guiding light received from the LED to a display panel, a wall portion arranged on a side (along arrow Z1) of the substrate opposite to the mounting surface of the substrate for radiating heat generated by the LED and a pressing portion pressed by the light guide plate body portion thereby pressing the mounting surface of the substrate toward a wall portion.

### BACKGROUND OF THE INVENTION

1. Field of the Invention

The present invention relates to an illuminator for a display and a display, and more particularly, it relates to an illuminator for a display including a light guide plate and a display including such an illuminator for a display.

2. Description of the Background Art

An illuminator for a display including a light guide plate is known in general, as disclosed in Japanese Patent Laying-Open No. 2008-166200, for example.

The aforementioned Japanese Patent Laying-Open No. 2008-166200 discloses a backlight (illuminator for a display) including a substrate mounted with an LED (light source), a light guide plate guiding light received from the LED to a display portion and a metal plate (heat radiation portion) radiating heat generated from the LED. In this backlight, the substrate is arranged on a side of the metal plate opposite to the light guide plate in a state where the LED is inserted into a mounting hole of the metal plate.

In the backlight (illuminator for a display) described in the aforementioned Japanese Patent Laying-Open No. 2008-166200, however, the substrate is merely arranged on the side of the metal plate opposite to the light guide plate in the state where the LED is inserted into the mounting hole of the metal plate, and hence the substrate may conceivably float up from the metal plate due to deformation of the substrate or the metal plate when the LED generates heat or the ambient temperature or moisture changes. In this case, the heat generated from the LED cannot be efficiently transmitted to the metal plate, and hence the same cannot be efficiently radiated.

### SUMMARY OF THE INVENTION

An illuminator for a display according to a first aspect of the present invention includes a substrate having a mounting surface mounted with a light source, a light guide plate including a light guide plate body portion guiding light received from the light source to a display portion, a heat radiation portion arranged on a side of the substrate opposite to the mounting surface for radiating heat generated from the light source and a pressing portion pressed by the light guide plate body portion thereby pressing the mounting surface of the substrate toward the heat radiation portion.

As hereinabove described, the illuminator for a display according to the first aspect of the present invention is provided with the pressing portion pressed by the light guide plate body portion thereby pressing the mounting surface of the substrate toward the heat radiation portion so that the pressing portion presses the substrate against the heat radiation portion arranged on the side of the substrate opposite to the mounting surface, whereby the substrate can be inhibited from floating up from the heat radiation portion due to deformation of the substrate or the heat radiation portion even if the light source generates heat or the ambient temperature or moisture changes. Thus, the illuminator for a display can efficiently radiate the heat generated from the light source. Consequently, the light source can be prevented from deterioration in optical performance and reduction in life.

In the aforementioned illuminator for a display according to the first aspect, a plurality of light sources are preferably provided on the mounting surface of the substrate at a constant interval, and the pressing portion is preferably formed to press the mounting surface of the substrate toward the heat radiation portion between the plurality of light sources arranged on the mounting surface of the substrate at the constant interval. According to this structure, light can be uniformly guided to the display portion due to the plurality of light sources arranged at the constant interval, and the pressing portion pressing the mounting surface of the substrate toward the heat radiation portion between the plurality of light sources arranged at the constant interval can effectively inhibit the substrate from floating up from the heat radiation portion.

In the aforementioned illuminator for a display according to the first aspect, the pressing portion is preferably integrally provided on the light guide plate body portion to protrude toward the substrate. According to this structure, the substrate can be inhibited from floating up from the heat radiation portion while suppressing increase in number of components.

In this case, a projecting portion serving as the pressing portion and a recess portion serving as a relief portion on which the light source is arranged are preferably integrally formed on a portion of the light guide plate opposed to the substrate. According to this structure, the substrate can be inhibited from floating up from the heat radiation portion while inhibiting the light guide plate from coming into contact with the substrate.

In the aforementioned illuminator for a display according to the first aspect, the pressing portion is preferably arranged between the mounting surface of the substrate and the light guide plate body portion, preferably consists of an elastically deformable member, and is preferably formed to be pressed by the light guide plate body portion thereby pressing the mounting surface of the substrate toward the heat radiation portion. According to this structure, the pressing portion is elastically deformed when pressed by the light guide plate body portion to press the mounting surface of the substrate, whereby the light guide plate body portion and the mounting surface of the substrate can be prevented from flawing.

In this case, the pressing portion is preferably formed to have a thickness larger than the thickness of the light source in a direction perpendicular to the mounting surface of the substrate in a state pressed by the light guide plate body portion and elastically deformed. According to this structure, the substrate can be inhibited from floating up from the heat radiation portion while inhibiting the light guide plate from coming into contact with the substrate.

In the aforementioned illuminator for a display having the pressing portion consisting of the elastically deformable member, the pressing portion is preferably formed to come into direct contact with either the light guide plate body portion or the mounting surface of the substrate in a state bonded to either the mounting surface of the substrate or the light guide plate body portion through a bonding layer and to be pressed by the light guide plate body portion thereby pressing the mounting surface of the substrate toward the heat radiation portion. According to this structure, the illuminator for a display can be assembled to bring the pressing portion bonded to either the mounting surface of the substrate or the light guide plate body portion through the bonding layer into contact with either the light guide plate body portion or the mounting surface of the substrate, whereby the assembling operation can be easily performed.

In the aforementioned illuminator for a display according to the first aspect, the pressing portion is preferably formed to press the mounting surface of the substrate toward the heat radiation portion in a state in surface contact with the mounting surface of the substrate. According to this structure, the pressing portion in surface contact with the mounting surface of the substrate can more reliably inhibit the substrate from floating up from the heat radiation portion.

In the aforementioned illuminator for a display according to the first aspect, the substrate is preferably arranged below the light guide plate, and the pressing portion is preferably formed to be pressed by the light guide plate body portion due to the own weight of the light guide plate body portion thereby pressing the mounting surface of the substrate toward the heat radiation portion. According to this structure, pressing force acting from the light guide plate body portion toward the mounting surface of the substrate can be easily produced through the own weight of the light guide plate body portion, whereby the substrate can be inhibited from floating up from the heat radiation portion without separately providing a member for urging the light guide plate body portion in a pressing direction.

The aforementioned illuminator for a display according to the first aspect preferably further includes an urging portion arranged on a side of the light guide plate opposite to the substrate for urging the light guide plate body portion toward the substrate, and the pressing portion is preferably formed to be pressed by the light guide plate body portion urged by the urging portion thereby pressing the mounting surface of the substrate toward the heat radiation portion. According to this structure, the urging portion can easily produce the pressing force acting from the light guide plate body portion toward the mounting surface of the substrate also when the own weight of the light guide plate body portion cannot be utilized in a case where the substrate is arranged on a side portion (by the side) of the light guide plate, for example.

In the aforementioned illuminator for a display according to the first aspect, the substrate having the light source is preferably arranged to be opposed to a side of the light guide plate, and the pressing portion is preferably formed to press the mounting surface of the substrate arranged to be opposed to the side of the light guide plate toward the heat radiation portion. According to this structure, an edge-lit illuminator for a display having a light source arranged on an edge (side) of a light guide plate can efficiently radiate heat generated from the light source.

In the aforementioned illuminator for a display according to the first aspect, the light source preferably includes a light-emitting device. According to this structure, the illuminator for a display can efficiently radiate heat generated from the light-emitting device.

The aforementioned illuminator for a display according to the first aspect preferably further includes a rear chassis, made of a metal, arranged to cover a back surface of the light guide plate, and the heat radiation portion is preferably integrally provided on said rear chassis. According to this structure, the illuminator for a display can efficiently radiate the heat generated from the light source while suppressing increase in number of components.

In the aforementioned illuminator for a display according to the first aspect, the substrate is preferably mounted on the heat radiation portion through a heat radiation tape having viscosity. According to this structure, the substrate can be brought into close contact with the heat radiation portion due to the pressing force of the pressing portion and adhesiveness of the heat radiation tape, whereby the illuminator for a display can more efficiently radiate the heat generated from the light source.

A display according to a second aspect of the present invention includes a display portion and an illuminator for a display, while the illuminator for a display includes a substrate having a mounting surface mounted with a light source, a light guide plate including a light guide plate body portion guiding light received from the light source to the display portion, a heat radiation portion arranged on a side of the substrate opposite to the mounting surface for radiating heat generated from the light source and a pressing portion pressed by the light guide plate body portion thereby pressing the mounting surface of the substrate toward the heat radiation portion.

As hereinabove described, the display according to the second aspect of the present invention is provided with the pressing portion pressed by the light guide plate body portion thereby pressing the mounting surface of the substrate toward the heat radiation portion so that the pressing portion presses the substrate against the heat radiation portion arranged on the side of the substrate opposite to the mounting surface, whereby the substrate can be inhibited from floating up from the heat radiation portion due to deformation of the substrate or the heat radiation portion even if the light source generates heat or the ambient temperature or moisture changes. Thus, the display can efficiently radiate the heat generated from the light source. Consequently, the light source can be prevented from deterioration in optical performance and reduction in life.

In the aforementioned display according to the second aspect, a plurality of light sources are preferably provided on the mounting surface of the substrate at a constant interval, and the pressing portion is preferably formed to press the mounting surface of the substrate toward the heat radiation portion between the plurality of light sources arranged on the mounting surface of the substrate at the constant interval. According to this structure, light can be uniformly guided to the display portion due to the plurality of light sources arranged at the constant interval, and the pressing portion pressing the mounting surface of the substrate toward the heat radiation portion between the plurality of light sources arranged at the constant interval can effectively inhibit the substrate from floating up from the heat radiation portion.

In the aforementioned display according to the second aspect, the pressing portion is preferably integrally provided on the light guide plate body portion to protrude toward the substrate. According to this structure, the substrate can be inhibited from floating up from the heat radiation portion while suppressing increase in number of components.

In the aforementioned display according to the second aspect, the pressing portion is preferably arranged between the mounting surface of the substrate and the light guide plate body portion, preferably consists of an elastically deformable member, and is preferably formed to be pressed by the light guide plate body portion thereby pressing the mounting surface of the substrate toward the heat radiation portion. According to this structure, the pressing portion is elastically deformed when pressed by the light guide plate body portion to press the mounting surface of the substrate, whereby the light guide plate body portion and the mounting surface of the substrate can be prevented from flawing.

In this case, the pressing portion is preferably formed to come into direct contact with either the light guide plate body portion or the mounting surface of the substrate in a state bonded to either the mounting surface of the substrate or the light guide plate body portion through a bonding layer and to be pressed by the light guide plate body portion thereby pressing the mounting surface of the substrate toward the heat radiation portion. According to this structure, the display can be assembled to bring the pressing portion bonded to either the mounting surface of the substrate or the light guide plate body portion through the bonding layer into contact with either the light guide plate body portion or the mounting surface of the substrate, whereby the assembling operation can be easily performed.

In the aforementioned display according to the second aspect, the pressing portion is preferably formed to press the mounting surface of the substrate toward the heat radiation portion in a state in surface contact with the mounting surface of the substrate. According to this structure, the pressing portion in surface contact with the mounting surface of the substrate can more reliably inhibit the substrate from floating up from the heat radiation portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing the overall structure of a liquid crystal display according to each of first to third embodiments of the present invention;

FIG. 2 is an exploded perspective view showing the internal structure of a display body of the liquid crystal display according to each of the first to third embodiments of the present invention;

FIG. 3 is a sectional view of the display body of the liquid crystal display according to the first embodiment of the present invention taken along the line 400-400 in FIG. 2;

FIG. 4 is a perspective view showing the structure of a substrate in the liquid crystal display according to the first embodiment of the present invention;

FIG. 5 is a front elevational view showing the structure of a backlight in the liquid crystal display according to the first embodiment of the present invention;

FIG. 6 is a sectional view of the display body of the liquid crystal display according to the second embodiment of the present invention taken along the line 400-400 in FIG. 2;

FIG. 7 is a front elevational view showing the structure of a backlight in the liquid crystal display according to the second embodiment of the present invention;

FIG. 8 is a perspective view detailedly showing the structures of a substrate and pressing portions in the liquid crystal display according to the second embodiment of the present invention;

FIG. 9 is a sectional view of a display body of the liquid crystal display according to the third embodiment of the present invention taken along the line 500-500 in FIG. 2; and

FIG. 10 is a front elevational view showing the structure of a backlight in the liquid crystal display according to the third embodiment of the present invention.

### DESCRIPTION OF THE PREFERRED EMBODIMENTS

Embodiments of the present invention are now described with reference to the drawings.

### First Embodiment

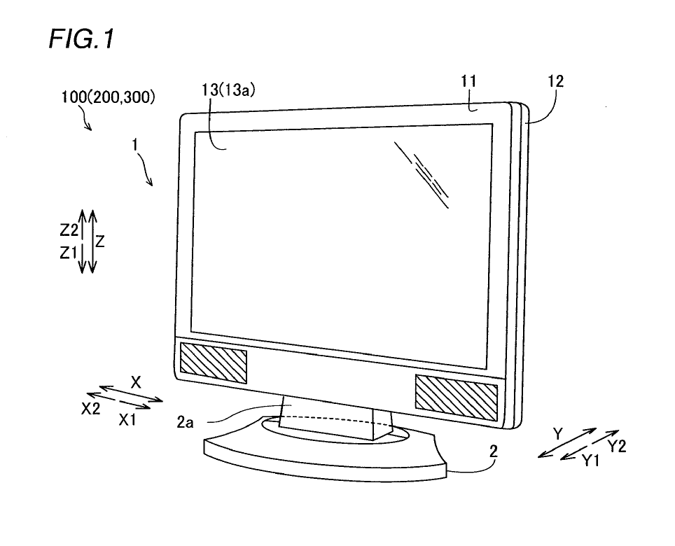

First, the structure of a liquid crystal display 100 according to a first embodiment of the present invention is described with reference to FIGS. 1 to 5. The liquid crystal display 100 illustrated below may be a liquid crystal television set having a TV tuner function, or a liquid crystal monitor or the like connected to a PC or the like. The liquid crystal display 100 is an example of the “display” in the present invention.

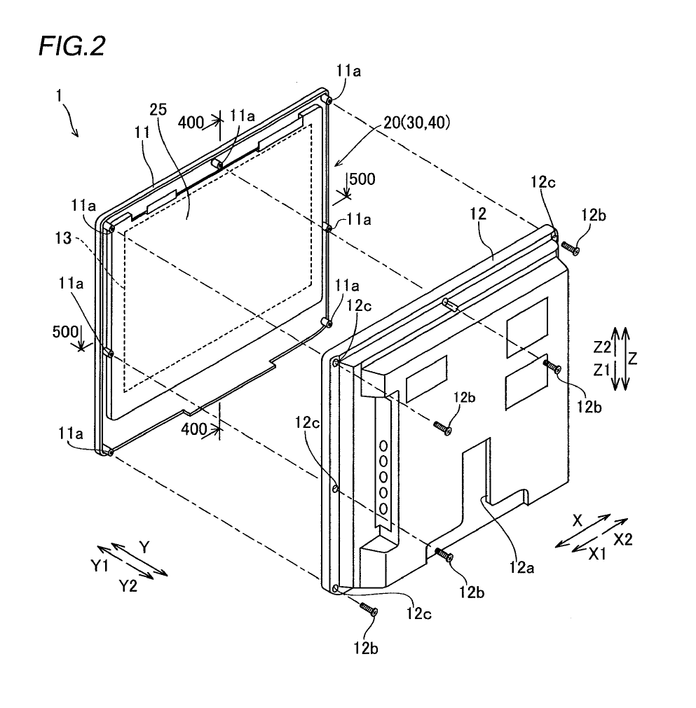

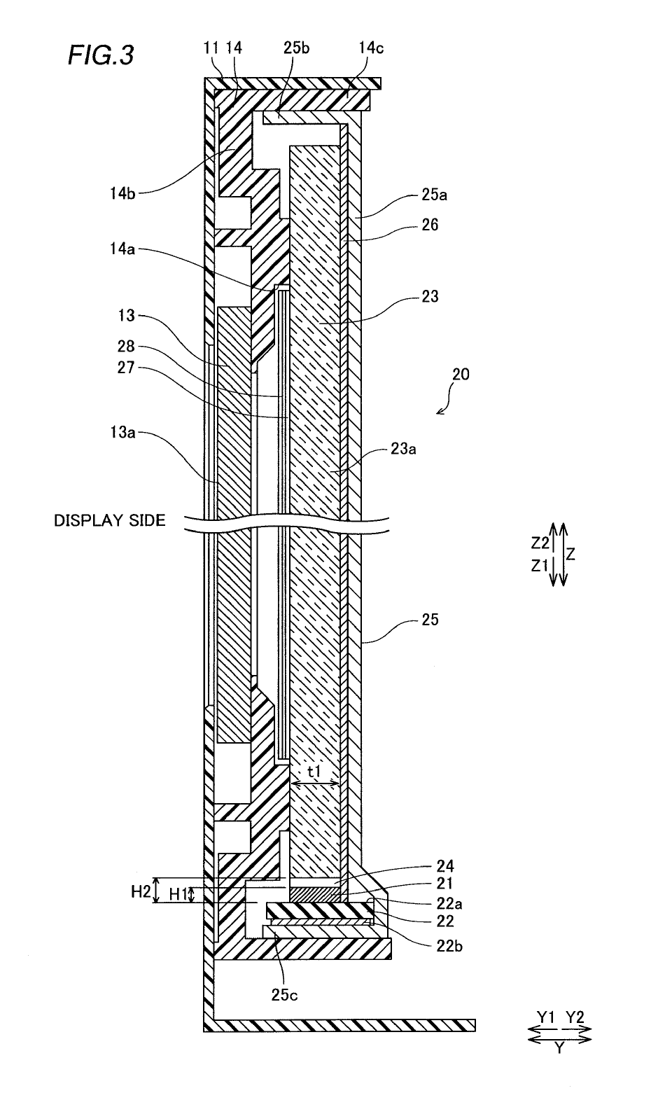

The liquid crystal display 100 according to the first embodiment of the present invention includes a display body 1 and a stand 2 supporting the display body 1 to be rotatable in the horizontal direction (direction X) and the anteroposterior direction (direction Y), as shown in FIG. 1. The display body 1 includes a front cabinet 11, a rear cabinet 12, a liquid crystal panel 13, a molded frame 14 and a backlight 20, as shown in FIGS. 2 and 3. The liquid crystal panel 13 is an example of the “display portion” in the present invention, and the backlight 20 is an example of the “illuminator for a display” in the present invention.

The front cabinet 11 is arranged on the front side (along arrow Y1) of the display body 1, as shown in FIG. 2. The front cabinet 11 consists of a resin member, and is formed to support the liquid crystal panel 13, the molded frame 14 and the backlight 20, as shown in FIG. 3. Further, the front cabinet 11 is provided to cover the vicinities of edge portions of a display surface 13a, described later, of the liquid crystal panel 13. Threaded holes 11a for fixing the rear cabinet 12 to the front cabinet 11 with screws 12b are provided on a rear outer peripheral portion (along arrow Y2) of the front cabinet 11, as shown in FIG. 2.

The rear cabinet 12 is arranged on the back side (along arrow Y2) of the display body 1, as shown in FIG. 2. The rear cabinet 12 consists of a resin member, and has a substantially rectangular shape in plan view. Further, the rear cabinet 12 is formed to cover the back side of the display body 1. A mounting portion 12a for mounting a leg portion 2a (see FIG. 1) of the stand 2 is integrally provided on the rear cabinet 12. Screw receiving holes 12c for receiving the screws 12b are provided on an outer peripheral portion of the rear cabinet 12. The rear cabinet 12 is fixed to the front cabinet 11 from the back side (along arrow Y2) toward the front side (along arrow Y1) with the screws 12b.

The liquid crystal panel 13 is arranged between and supported by the front cabinet 11 and the molded frame 14, as shown in FIG. 3. The liquid crystal panel 13 is formed to be capable of displaying images on the display surface 13a provided on the front side (along arrow Y1). The liquid crystal panel 13 has a substantially rectangular shape as viewed from the front side (along arrow Y1). Further, the liquid crystal panel 13 is formed to receive light from the backlight 20 arranged on the back side (along arrow Y2). In addition, the liquid crystal panel 13 is connected to a control board portion (not shown) of the display body 1.

The molded frame 14 consists of a resin member, and is arranged between the front cabinet 11 and the backlight 20, as shown in FIG. 3. The molded frame 14 is provided in the form of a frame. More specifically, the molded frame 14 includes a receiving portion 14b having a substantially rectangular opening 14a on a central region thereof for receiving the liquid crystal panel 13 thereon and a wall portion 14c protruding backward (along arrow Y2) along an outer peripheral portion of the receiving portion 14b. On the front side (along arrow Y1) of the receiving portion 14b of the molded frame 14, the liquid crystal panel 13 is mounted on a position overlapping with the opening 14a in the direction Y.

The backlight 20 is formed to emit the light toward the back surface (along arrow Y2) of the liquid crystal panel 13. Thus, the liquid crystal display 100 is so formed that the liquid crystal panel 13 can display bright and clear images. The backlight 20 is an edge-lit illuminator having light sources arranged on an edge (side) of a light guide plate 23. The backlight 20 includes a plurality of LEDs 21, a substrate 22, the light guide plate 23, a plurality of pressing portions 24 (see FIG. 5), a rear chassis 25, a reflecting sheet 26, a diffusing sheet 27 and a plurality of lens sheets 28, as shown in FIG. 3. The LEDs 21 are examples of the “light source” or the “light-emitting device” in the present invention.

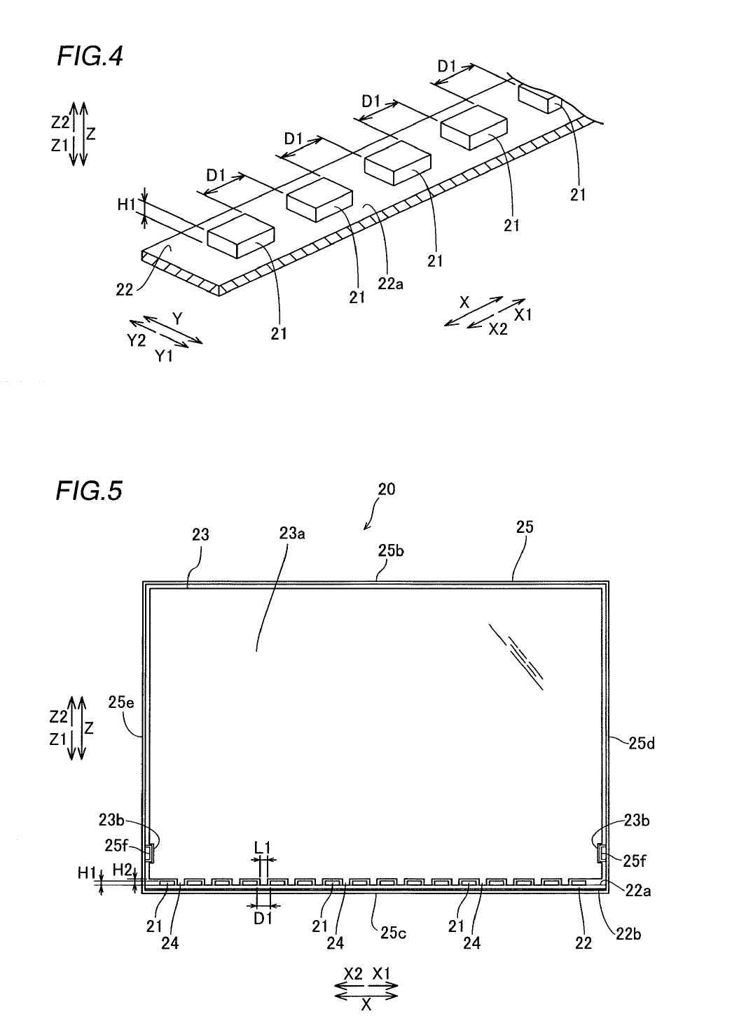

The plurality of LEDs 21 are mounted on a mounting surface 22a of the substrate 22 at substantially equal intervals D1 along the direction X, as shown in FIG. 4. Further, the LEDs 21 are arranged on a lower side (along arrow Z1) of a light guide plate body portion 23a, described later, of the light guide plate 23, and formed to apply light to the light guide plate 23. In addition, the LEDs 21 have a height H1 (in a direction Z), as shown in FIGS. 3 and 5.

The substrate 22 is mounted on an inner side surface (surface along arrow Z2) of a lower wall portion 25c (along arrow Z1), described later, of the rear chassis 25 through a heat radiation tape 22b, as shown in FIG. 3. The substrate 22 is made of glass epoxy resin, and has the mounting surface 22a (see FIG. 4) mounted with the LEDs 21 on an upper side (along arrow Z2). Further, the substrate 22 has wires (not shown), and connects the plurality of LEDs 21 and the control board portion (not shown) with each other. The heat radiation tape 22b is made of a material easily conducting heat, and has adhesiveness. The substrate 22 is arranged to be opposed to the lower side (along arrow Z1) of the light guide plate 23.

The light guide plate 23 is made of transparent acrylic resin having translucency, and provided in the form of a flat plate having a thickness t1 (in the direction Y), as shown in FIG. 3. The light guide plate 23 has a substantially rectangular shape in plan view, as shown in FIG. 5. Further, the light guide plate 23 has the light guide plate body portion 23a guiding the light received from the LEDs 21 to the liquid crystal panel 13 and a pair of positioning portions 23b positioning the light guide plate 23 with respect to the rear chassis 25. In addition, the light guide plate 23 is arranged to fit into the rear chassis 25 through the reflecting sheet 26 (see FIG. 3) mounted on a surface of a bottom portion 25a, described later, of the rear chassis 25. The light guide plate body portion 23a is arranged above the LEDs 21 and the pressing portions 24 (along arrow Z2). Thus, the liquid crystal display 100 is so formed that the light from the LEDs 21 enters the light guide plate body portion 23a from below (along arrow Z1), is repeatedly multiple-reflected by the reflecting sheet 26 and outgoes from the front side (along arrow Y1) of the light guide plate body portion 23a toward the liquid crystal panel 13. The light guide plate body portion 23a is formed to vertically press the pressing portions 24 downward (along arrow Z1) with prescribed pressure due to the own weight thereof.

According to the first embodiment, the plurality of pressing portions 24 are integrally provided on the light guide plate body portion 23a to protrude toward the substrate 22, as shown in FIG. 5. In other words, projecting portions serving as the pressing portions 24 and recess portions serving as relief portions on which the LEDs 21 are arranged are integrally formed on a portion of the light guide plate 23 opposed to the substrate 22. More specifically, the plurality of pressing portions 24 are substantially in the form of rectangular parallelepipeds, and provided on the lower side (along arrow Z1) of the light guide plate body portion 23a at constant intervals along the direction X. The pressing portions 24 have a length L1, smaller than the interval D1 between the LEDs 21, in the direction X, as shown in FIG. 5. Further, the plurality of pressing portions 24 are arranged between the LEDs 21 respectively. In other words, the pressing portions 24 are formed to press the mounting surface 22a of the substrate 22 toward the wall portion 25c, described later, of the rear chassis 25 between the LEDs 21. In addition, the pressing portions 24 have a height H2 (in the direction Z) larger than the height H1 of the LEDs 21, as shown in FIGS. 3 and 4. Thus, the liquid crystal display 100 is so formed that the light guide plate body portion 23a does not come into contact with the LEDs 21. The pressing portions 24 are formed to be in surface contact with the mounting surface 22a of the substrate 22. Further, the pressing portions 24 are formed to be pressed by the light guide plate body portion 23a due to the own weight thereof thereby pressing the mounting surface 22a of the substrate 22 toward the wall portion 25c, described later, of the rear chassis 25.

The rear chassis 25 consists of a metal member, and has the bottom portion 25a (see FIG. 3), wall portions 25b to 25e (see FIG. 5) and a pair of positioning portions 25f. The bottom portion 25a is arranged on the back side (along arrow Y2) of the light guide plate 23, and has a substantially rectangular shape in plan view. Further, the bottom portion 25a is formed to cover the back sides (along arrow Y2) of the light guide plate 23 and the reflecting sheet 26. The wall portions 25b to 25e are provided to project frontward (along arrow Y1) along the outer peripheral portion of the bottom portion 25a. The wall portions 25b and 25e are arranged on the upper side (along arrow Z2), the lower side (along arrow Z1) and the sides along arrows X1 and X2 respectively, as shown in FIG. 5. The heat radiation tape 22b, the substrate 22, the pressing portions 24 and the light guide plate body portion 23a are arranged on the upper side (along arrow Z2) of the wall portion 25c to pile up successively from the lower side (along arrow Z1). The wall portion 25c is formed to radiate the heat generated by the LEDs 21 through the heat radiation tape 22b. The pair of positioning portions 25f are arranged on lower portions of the wall portions 25d and 25e respectively, and formed to position the light guide plate 23 with respect to the rear chassis 25 by coming into contact with the pair of positioning portions 23b of the light guide plate 23. The wall portion 25c is an example of the “heat radiation portion” in the present invention.

The reflecting sheet 26 is arranged between the light guide plate 23 and the bottom portion 25a of the rear chassis 25, and formed to reflect light received from the light guide plate 23 frontward (along arrow Y1). The diffusing sheet 27 is stacked on the front side (along arrow Y1) of the light guide plate 23. The plurality of lens sheets 28 are stacked on the front side (along arrow Y1) of the diffusing sheet 27. The light outgoing from the light guide plate 23 is transmitted through the diffusing sheet 27 and the plurality of lens sheets 28, to thereafter reach the back side (along arrow Y2) of the liquid crystal panel 13. At this time, the light is adjusted to a state of backlight having desired brightness with no irregularity.

According to the first embodiment, as hereinabove described, the liquid crystal display 100 is provided with the pressing portions 24 pressed by the light guide plate body portion 23a thereby pressing the mounting surface 22a of the substrate 22 toward the wall portion 25c so that the pressing portions 24 press the substrate 22 against the wall portion 25c of the rear chassis 25 arranged on the side of the substrate 22 opposite to the mounting surface 22a, whereby the substrate 22 can be inhibited from floating up from the wall portion 25c due to deformation of the substrate 22 or the wall portion 25c even if the LEDs 21 generate heat or the ambient temperature or moisture changes. Thus, the wall portion 25c can efficiently radiate the heat generated by the LEDs 21. Consequently, the LEDs 21 can be prevented from deterioration in optical performance and reduction in life.

According to the first embodiment, the plurality of LEDs 21 are provided on the mounting surface 22a of the substrate 22 at the constant intervals while the pressing portions 24 are formed to press the mounting surface 22a of the substrate 22 toward the wall portion 25c of the rear chassis 25 between the plurality of LEDs 21 arranged on the mounting surface 22a of the substrate 22 at the constant intervals, whereby the light can be uniformly guided to the liquid crystal panel 13 due to the plurality of LEDs 21 arranged at the constant intervals and the pressing portions 24 pressing the mounting surface 22a of the substrate 22 toward the wall portion 25c between the plurality of LEDs 21 arranged at the constant intervals can effectively inhibit the substrate 22 from floating up from the wall portion 25c.

According to the first embodiment, the pressing portions 24 are integrally provided on the light guide plate body portion 23a to protrude toward the substrate 22, whereby the substrate 22 can be inhibited from floating up from the wall portion 25c while suppressing increase in number of components.

According to the first embodiment, the projecting portions serving as the pressing portions 24 and the recess portions serving as the relief portions on which the LEDs 21 are arranged are integrally formed on the portion of the light guide plate 23 opposed to the substrate 22, whereby the substrate 22 can be inhibited from floating up from the wall portion 25c while inhibiting the light guide plate 23 from coming into contact with the substrate 22.

According to the first embodiment, the pressing portions 24 are formed to press the mounting surface 22a of the substrate 22 toward the wall portion 25c of the rear chassis 25 in the state in surface contact with the mounting surface 22a of the substrate 22, whereby the pressing portions 24 in surface contact with the mounting surface 22a of the substrate 22 can more reliably inhibit the substrate 22 from floating up from the wall portion 25.

According to the first embodiment, the substrate 22 is arranged below the light guide plate 23 (along arrow Z1) and the pressing portions 24 are formed to be pressed by the light guide plate body portion 23a due to the own weight thereof thereby pressing the mounting surface 22a of the substrate 22 toward the wall portion 25c of the rear chassis 25 so that pressing force acting from the light guide plate body portion 23a toward the mounting surface 22a of the substrate 22 can be easily produced through the own weight of the light guide plate body portion 23a, whereby the substrate 22 can be inhibited from floating up from the wall portion 25c without separately providing a member for urging the light guide plate body portion 23a in the pressing direction.

According to the first embodiment, the substrate 22 having the LEDs 21 is arranged to be opposed to the lower side (along arrow Z1) of the light guide plate 23 and the pressing portions 24 are formed to press the mounting surface 22a of the substrate 22 arranged to be opposed to the lower side (along arrow Z1) of the light guide plate 23 toward the wall portion 23c, whereby the edge-lit backlight 20 having the LEDs 21 arranged on the edge (side) of the light guide plate 23 can efficiently radiate the heat generated from the LEDs 21.

According to the first embodiment, the wall portion 25c is integrally provided on the rear chassis 25, whereby the heat generated from the LEDs 21 can be efficiently radiated while suppressing increase in number of components.

According to the first embodiment, the substrate 22 is mounted on the wall portions 25c through the heat radiation tape 22 having viscosity so that the substrate 22 can be brought into close contact with the wall portion 25c due to the pressing force of the pressing portions 24 and the adhesiveness of the heat radiation tape 22b, whereby the heat generated from the LEDs 21 can be more efficiently radiated.

### Second Embodiment

The structure of a liquid crystal display 200 (see FIG. 1) according to a second embodiment of the present invention is now described with reference to FIGS. 1, 2 and 6 to 8. In the liquid crystal display 200 according to the second embodiment, pressing portions 34 are constituted of elastically deformable members independent of a light guide plate body portion 33a, dissimilarly to the liquid crystal display 100 according to the aforementioned first embodiment in which the pressing portions 24 are integrally provided on the light guide plate body portion 23a. The liquid crystal display 200 is an example of the “display” in the present invention.

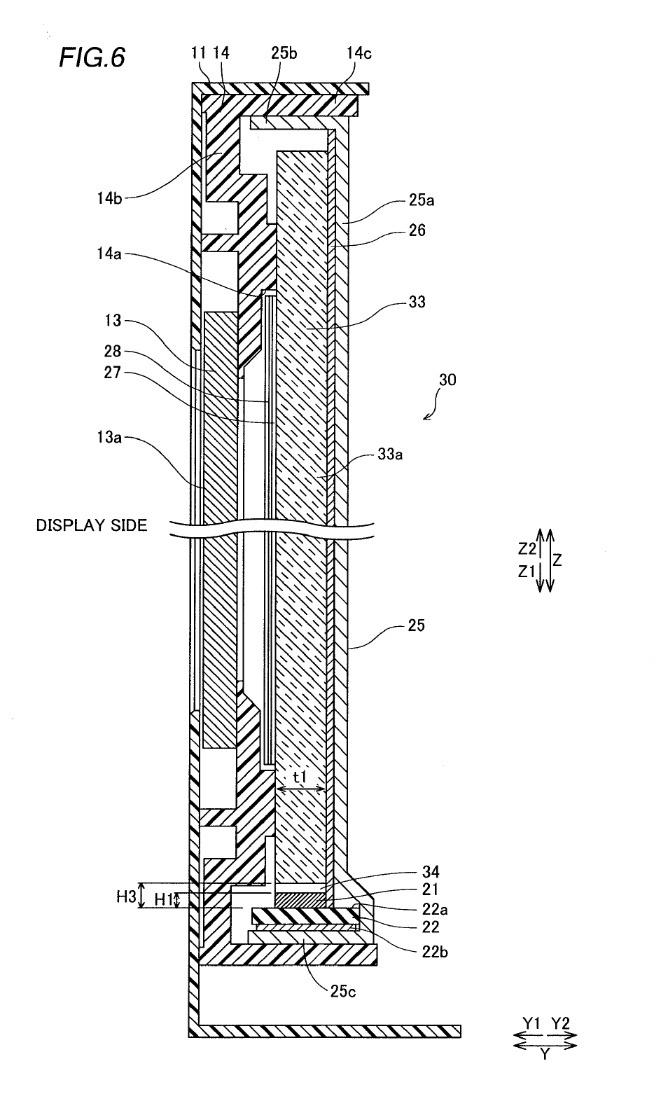

The liquid crystal display 200 according to the present invention includes a display body 1 and a stand 2 supporting the display body 1 to be rotatable in the horizontal direction (direction X) and the anteroposterior direction (direction Y), as shown in FIG. 1. The display body 1 includes a front cabinet 11, a rear cabinet 12, a liquid crystal panel 13, a molded frame 14 and a backlight 30, as shown in FIGS. 2 and 6. The liquid crystal panel 13 is an example of the “display portion” in the present invention, and the backlight 30 is an example of the “illuminator for a display” in the present invention.

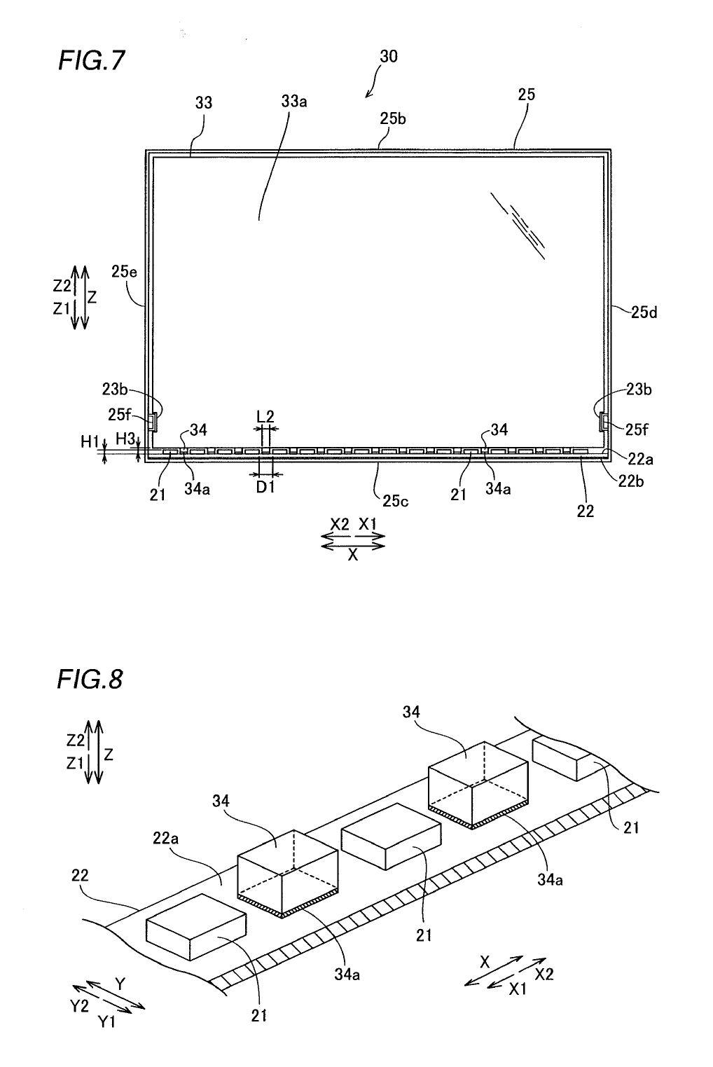

The backlight 30 is formed to emit light toward the back surface (along arrow Y2) of the liquid crystal panel 13. Thus, the liquid crystal display 200 is so formed that the liquid crystal panel 13 can display bright and clear images. The backlight 30 is an edge-lit illuminator having light sources arranged on an edge (side) of a light guide plate 33. The backlight 30 includes a plurality of LEDs 21, a substrate 22, the light guide plate 33, the plurality of pressing portions 34 (see FIG. 7), a rear chassis 25, a reflecting sheet 26, a diffusing sheet 27 and a plurality of lens sheets 28, as shown in FIG. 6. The LEDs 21 are examples of the “light source” or the “light-emitting device” in the present invention.

The light guide plate 33 is made of transparent acrylic resin having translucency, and provided in the form of a flat plate having a thickness t1 (in the direction Y), as shown in FIG. 6. The light guide plate 33 has a substantially rectangular shape in plan view, as shown in FIG. 7. Further, the light guide plate 33 has the light guide plate body portion 33a guiding the light received from the LEDs 21 to the liquid crystal panel 13 and a pair of positioning portions 23b positioning the light guide plate 23 with respect to the rear chassis 25. In addition, the light guide plate 33 is arranged to fit into the rear chassis 25 through the reflecting sheet 26 (see FIG. 3) mounted on a surface of a bottom portion 25a, described later, of the rear chassis 25. The light guide plate body portion 33a is arranged above the LEDs 21 and the pressing portions 34 (along arrow Z2). Thus, the liquid crystal display 200 is so formed that the light from the LEDs 21 enters the light guide plate body portion 33a from below (along arrow Z1), is repeatedly multiple-reflected by the reflecting sheet 26 and outgoes from the front side (along arrow Y1) of the light guide plate body portion 33a toward the liquid crystal panel 13. The light guide plate body portion 33a is formed to vertically press the pressing portions 34 downward (along arrow Z1) with prescribed pressure due to the own weight thereof.

According to the second embodiment, the plurality of pressing portions 34 consist of elastic members made of silicone resin, and are provided on a mounting surface 22a of the substrate 22, as shown in FIGS. 7 and 8. More specifically, the plurality of pressing portions 34 are substantially in the form of rectangular parallelepipeds (see FIG. 8), and provided on a lower side (along arrow Z1) of the light guide plate body portion 33a at constant intervals along the direction X, as shown in FIG. 7. The pressing portions 34 are fixed to the mounting surface 22a of the substrate 22 with double-faced adhesive tapes 34a, as shown in FIG. 8. The pressing portions 34 have a length L2, smaller than the interval D1 between the LEDs 21, in the direction X, as shown in FIG. 7. Further, the plurality of pressing portions 34 are arranged between the LEDs 21 respectively. In other words, the pressing portions 34 are formed to press the mounting surface 22a of the substrate 22 toward a wall portion 25c of the rear chassis 25 between the LEDs 21. In addition, the pressing portions 34 have a height H3 (in a direction Z) larger than the height H1 of the LEDs 21, as shown in FIG. 7. The pressing portions 34 are so formed that the light guide plate body portion 33a does not come into contact with the LEDs 21, although the same are elastically deformable. In other words, the pressing portions 34 are formed to have a thickness (height) larger than that of the LEDs 21 in a direction (direction Z) perpendicular to the mounting surface 22a of the substrate 22 in a state pressed by the light guide plate body portion 33a and elastically deformed. The pressing portions 34 are formed to be in surface contact with the mounting surface 22a of the substrate 22. Further, the pressing portions 34 are formed to be pressed by the light guide plate body portion 33a due to the own weight thereof thereby pressing the mounting surface 22a of the substrate 22 toward the wall portion 25c of the rear chassis 25. The wall portion 25c is an example of the “heat radiation portion” in the present invention, and the double-faced adhesive tapes 34a are examples of the “bonding layer” in the present invention.

The remaining structure of the second embodiment is similar to that of the aforementioned first embodiment.

Also according to the structure of the second embodiment, as hereinabove described, the liquid crystal display 200 is provided with the pressing portions 34 pressed by the light guide plate body portion 33a thereby pressing the mounting surface 22a of the substrate 22 toward the wall portion 25c the rear chassis 25. Even if the LEDs 21 generate heat or the ambient temperature or moisture changes, therefore, the wall portion 25c can efficiently radiate the heat generated from the LEDs 21. Consequently, the LEDs 21 can be prevented from deterioration in optical performance and reduction in life.

According to the second embodiment, as hereinabove described, the pressing portions 34 are made of silicone resin and arranged between the mounting surface 22a of the substrate 22 and the light guide plate body portion 33a so that the pressing portions 34 made of silicone resin are elastically deformed when pressed by the light guide plate body portion 33a thereby pressing the mounting surface 22a of the substrate 22, whereby the light guide plate body portion 33a and the mounting surface 22a of the substrate 22 can be prevented from flawing.

According to the second embodiment, the pressing portions 34 are formed to have the thickness larger than that of the LEDs 21 in the direction (direction Z) perpendicular to the mounting surface 22a of the substrate 22 in the state pressed by the light guide plate body portion 33a and elastically deformed, whereby the substrate 22 can be inhibited from floating up from the wall portion 25c while inhibiting the light guide plate 33 from coming into contact with the substrate 22.

According to the second embodiment, the pressing portions 34 are bonded to the mounting surface 22a of the substrate 22 through the double-faced adhesive tapes 34a so that the backlight 30 can be assembled to bring the pressing portions 34 in the state bonded to the mounting surface 22a of the substrate 22 through the double-faced adhesive tapes 34a into contact with the light guide plate body portion 33a, whereby the assembling operation can be easily performed.

The remaining effects of the second embodiment are similar to those of the aforementioned first embodiment.

### Third Embodiment

The structure of a liquid crystal display 300 (see FIG. 1) according to a third embodiment of the present invention is now described with reference to FIGS. 1, 2, 9 and 10. In the liquid crystal display 300 according to the third embodiment, a substrate 22 is arranged in a lateral direction (direction X) with respect to a light guide plate 43, dissimilarly to the liquid crystal displays 100 and 200 according to the aforementioned first and second embodiments, in each of which the substrate 22 is arranged below the light guide plate 23 (33). The liquid crystal display 300 is an example of the “display” in the present invention.

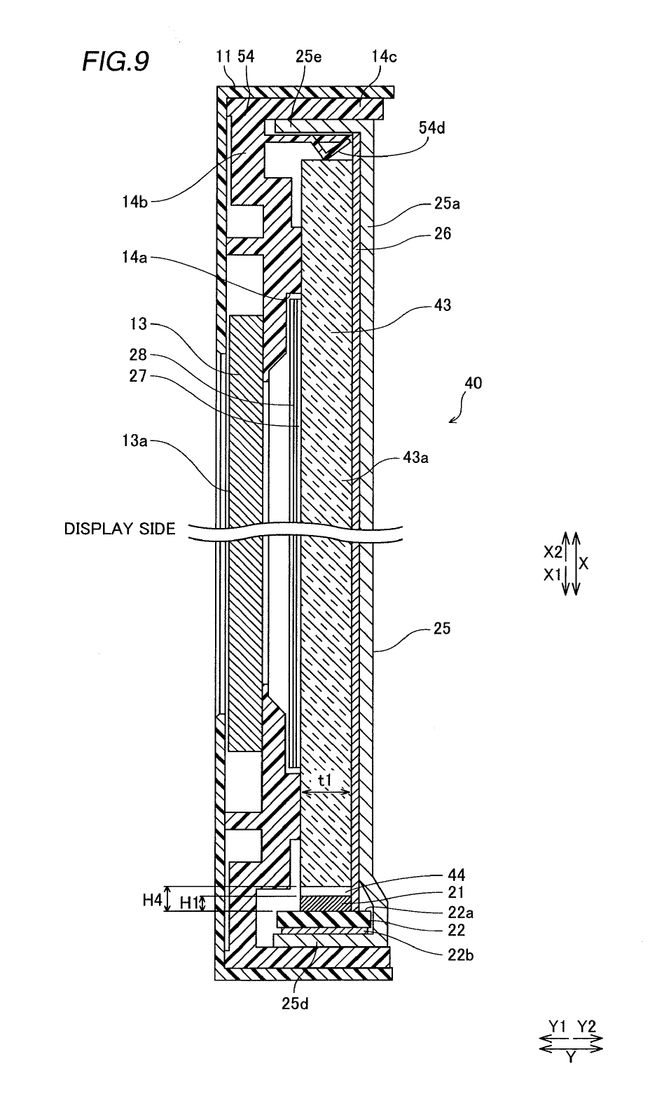

The liquid crystal display 300 according to the third embodiment includes a display body 1 and a stand 2 supporting the display body 1 to be rotatable in the horizontal direction (direction X) and the anteroposterior direction (direction Y), as shown in FIG. 1. The display body 1 includes a front cabinet 11, a rear cabinet 12, a liquid crystal panel 13, a backlight 40 and a molded frame 54, as shown in FIGS. 2 and 9. The liquid crystal panel 13 is an example of the “display portion” in the present invention, and the backlight 40 is an example of the “illuminator for a display” in the present invention.

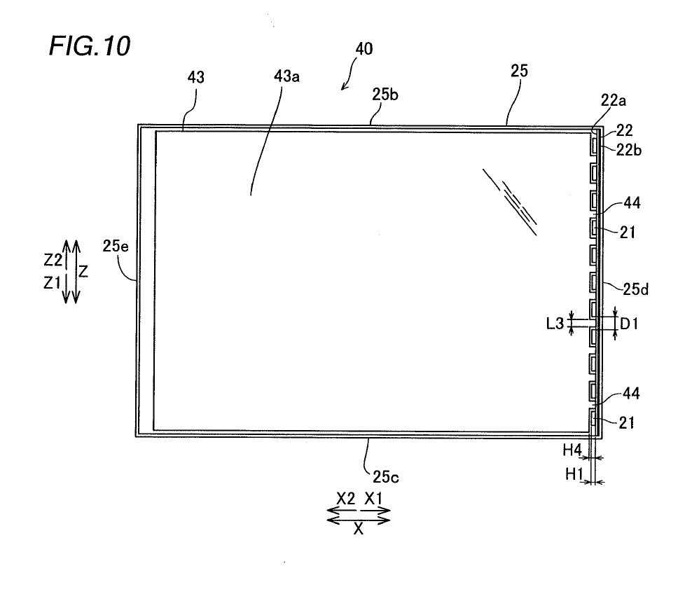

The backlight 40 is formed to emit light toward a back surface (along arrow Y2) of the liquid crystal panel 13. Thus, the liquid crystal display 300 is so formed that the liquid crystal panel 13 can display bright and clear images. The backlight 40 is an edge-lit illuminator having light sources arranged on an edge (side) of the light guide plate 43. The backlight 40 includes a plurality of LEDs 21, the substrate 22, the light guide plate 43, a plurality of pressing portions 44 (see FIG. 10), a rear chassis 25, a reflecting sheet 26, a diffusing sheet 27 and a plurality of lens sheets 28, as shown in FIG. 9. The LEDs 21 are examples of the “light source” or the “light-emitting device” in the present invention.

The plurality of LEDs 21 are mounted on a mounting surface 22a of the substrate 22 at substantially equal intervals D1 along the direction Z, as shown in FIG. 10. Further, the LEDs 21 are arranged on a side of the light guide plate 43 along arrow X1, and formed to apply light to the light guide plate 43, as shown in FIGS. 9 and 10. In addition, the LEDs 21 have a height H1 (in the direction X), as shown in FIGS. 9 and 10.

According to the third embodiment, the substrate 22 is mounted on an inner side surface (surface along arrow X2) of a wall portion 25d of the rear chassis 25 along arrow X1 (in the lateral direction) through a heat radiation tape 22b, as shown in FIG. 9. The substrate 22 is made of glass epoxy resin, and has the mounting surface 22a mounted with the LEDs 21 along arrow X2, as shown in FIGS. 9 and 10. Further, the substrate 22 has wires (not shown), and connects the plurality of LEDs 21 and a control board portion (not shown) with each other. The heat radiation 22b is made of a material easily conducting heat, and has adhesiveness. The substrate 22 is arranged to be opposed to a side of the light guide plate 43 along arrow X1. The wall portion 25d is an example of the “heat radiation portion” in the present invention.

The plurality of pressing portions 44 are integrally provided on the light guide plate body portion 43a to protrude toward the substrate 22, as shown in FIG. 10. In other words, projecting portions serving as the pressing portions 44 and recess portions serving as relief portions on which the LEDs 21 are arranged are integrally formed on a portion of the light guide plate 43 opposed to the substrate 22. More specifically, the plurality of pressing portions 44 are substantially in the form of rectangular parallelepipeds, and provided on a side of the light guide plate body portion 43a along arrow X1 at constant intervals along the direction Z (vertical direction). The pressing portions 44 have a length L3, smaller than the interval D1 between the LEDs 21, in the direction Z, as shown in FIG. 10. Further, the plurality of pressing portions 44 are arranged between the LEDs 21 respectively. In other words, the pressing portions 44 are formed to press the mounting surface 22a of the substrate 22 toward the wall portion 25c of the rear chassis 25 between the LEDs 21. In addition, the pressing portions 44 have a height H4 (in the direction X) larger than the height H1 of the LEDs 21, as shown in FIGS. 9 and 10. Thus, the liquid crystal display 300 is so formed that the light guide plate body portion 43a does not come into contact with the LEDs 21. The pressing portions 44 are formed to be in surface contact with the mounting surface 22a of the substrate 22. Further, the pressing portions 44 are formed to be pressed by the light guide plate body portion 43a urged by an urging portion 54d described later thereby pressing the mounting surface 22a of the substrate 22 toward the wall portion 25c of the rear chassis 25.

According to the third embodiment, the molded frame 54 consists of a resin member, and includes a receiving portion 14b having a substantially rectangular opening 14a on a central region thereof for receiving the liquid crystal panel 13 thereon, a wall portion 14c protruding backward (along arrow Y2) along an outer peripheral portion of the receiving portion 14b and the urging portion 54d provided to extend backward (along arrow Y2) from the receiving portion 14b along arrow X2, as shown in FIG. 9. The urging portion 54d is arranged on a side (along arrow X2) of the light guide plate 43 opposite to the substrate 22, extends backward (along arrow Y2) from the receiving portion 14b, and is bent to protrude along arrow X1. Further, the urging portion 54d has elasticity in the direction X, and is formed to urge the light guide plate body portion 43a toward the substrate 22.

The remaining structure of the third embodiment is similar to that of the aforementioned first embodiment.

Also according to the structure of the third embodiment, as hereinabove described, the liquid crystal display 300 is provided with the pressing portions 44 pressed by the light guide plate body portion 43a thereby pressing the mounting surface 22a of the substrate 22 toward the wall portion 25d the rear chassis 25. Even if the LEDs 21 generate heat or the ambient temperature or moisture changes, therefore, the wall portion 25d can efficiently radiate the heat generated from the LEDs 21. Consequently, the LEDs 21 can be prevented from deterioration in optical performance and reduction in life.

According to the third embodiment, as hereinabove described, the urging portion 54d urging the light guide plate body portion 43a toward the substrate 22 is provided on the side (along arrow X2) of the light guide plate 43 opposite to the substrate 22 and the pressing portions 44 are formed to be pressed by the light guide plate body portion 43a urged by the urging portion 54d thereby pressing the mounting surface 22a of the substrate 22 toward the wall portion 25d of the rear chassis 25, whereby the urging portion 54d can easily produce pressing force acting from the light guide plate body portion 43a toward the mounting surface 22a of the substrate 22 also when the own weight of the light guide plate body portion 43a cannot be utilized.

The remaining effects of the third embodiment are similar to those of the aforementioned first embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while the backlight as the illuminator for a display according to the present invention is applied to the liquid crystal television set having a TV tuner function, or the liquid crystal monitor or the like connected to a PC or the like in each of the aforementioned first to third embodiments, the present invention is not restricted to this. The illuminator for a display according to the present invention may alternatively be applied to a liquid crystal monitor loaded on a car navigation system or an information display monitor (liquid crystal monitor) loaded in a train, a bus, a ship or an airplane, for example.

While the wall portion as the heat radiation portion in the present invention is integrally provided on the rear chassis in each of the aforementioned first to third embodiments, the present invention is not restricted to this. According to the present invention, a dedicated member may alternatively be provided as the heat radiation portion.

While the pressing portions are in the form of rectangular parallelepipeds in each of the aforementioned first to third embodiments, the present invention is not restricted to this. According to the present invention, the pressing portions may alternatively have shapes other than those of rectangular parallelepipeds. For example, the pressing portions may have triangular or trapezoidal shapes as viewed from the front side, or may have curved shapes. In this case, the pressing portions may not be in surface contact with the mounting surface of the substrate.

While the pressing portions are arranged on all positions between the light sources in each of the aforementioned first to third embodiments, the present invention is not restricted to this. According to the present invention, the pressing portions may not be arranged on all positions between the light sources. For example, the pressing portions may be arranged on partial positions between the light sources.

While the pressing portions are bonded to the mounting surface of the substrate through the double-faced adhesive tapes 34a as bonding layers in the aforementioned second embodiment, the present invention is not restricted to this. According to the present invention, the pressing portions may alternatively be bonded to the light guide plate body portion through bonding layers. In this case, the pressing portions are preferably formed to be directly in contact with the mounting surface of the substrate.

While the pressing portions are fixed to the mounting surface of the substrate through the double-faced adhesive tapes 34a as bonding layers in the aforementioned second embodiment, the present invention is not restricted to this. According to the present invention, the pressing portions may alternatively be fixed to the mounting surface of the substrate through bonding layers other than the double-faced adhesive tapes. For example, the pressing portions may be fixed to the mounting surface of the substrate with an adhesive or the like.

While the substrate is arranged in the lateral direction with respect to the light guide plate in the structure provided with the urging portion in the aforementioned third embodiment, the present invention is not restricted to this. According to the present invention, the substrate may alternatively be arranged on the upper side or the lower side of the light guide plate in the structure provided with the urging portion. In this case, the urging portion is arranged on the side of the light guide plate opposite to the substrate.

What is claimed is:

1. An illuminator for a display, comprising:
a substrate having a mounting surface mounted with a light source;
a light guide plate including a light guide plate body portion guiding light received from said light source to a display portion;
a heat radiation portion arranged on a side of said substrate opposite to said mounting surface for radiating heat generated by said light source; and
a pressing portion pressed by said light guide plate body portion thereby pressing said mounting surface of said substrate toward said heat radiation portion.

2. The illuminator for a display according to claim 1, wherein
a plurality of said light sources are provided on said mounting surface of said substrate at a constant interval, and
said pressing portion is formed to press said mounting surface of said substrate toward said heat radiation portion between said plurality of light sources arranged on said mounting surface of said substrate at said constant interval.

3. The illuminator for a display according to claim 1, wherein
said pressing portion is integrally provided on said light guide plate body portion to protrude toward said substrate.

4. The illuminator for a display according to claim 3, wherein
a projecting portion serving as said pressing portion and a recess portion serving as a relief portion on which said light source is arranged are integrally formed on a portion of said light guide plate opposed to said substrate.

5. The illuminator for a display according to claim 1, wherein
said pressing portion is arranged between said mounting surface of said substrate and said light guide plate body portion, consists of an elastically deformable member, and is formed to be pressed by said light guide plate body portion thereby pressing said mounting surface of said substrate toward said heat radiation portion.

6. The illuminator for a display according to claim 5, wherein
said pressing portion is formed to have a thickness larger than the thickness of said light source in a direction perpendicular to said mounting surface of said substrate in a state pressed by said light guide plate body portion and elastically deformed.

7. The illuminator for a display according to claim 5, wherein
said pressing portion is formed to come into direct contact with either said light guide plate body portion or said mounting surface of said substrate in a state bonded to either said mounting surface of said substrate or said light guide plate body portion through a bonding layer and to be pressed by said light guide plate body portion thereby pressing said mounting surface of said substrate toward said heat radiation portion.

8. The illuminator for a display according to claim 1, wherein
said pressing portion is formed to press said mounting surface of said substrate toward said heat radiation portion in a state in surface contact with said mounting surface of said substrate.

9. The illuminator for a display according to claim 1, wherein
said substrate is arranged below said light guide plate, and
said pressing portion is formed to be pressed by said light guide plate body portion due to the own weight of said light guide plate body portion thereby pressing said mounting surface of said substrate toward said heat radiation portion.

10. The illuminator for a display according to claim 1, further comprising an urging portion arranged on a side of said light guide plate opposite to said substrate for urging said light guide plate body portion toward said substrate, wherein
said pressing portion is formed to be pressed by said light guide plate body portion urged by said urging portion thereby pressing said mounting surface of said substrate toward said heat radiation portion.

11. The illuminator for a display according to claim 1, wherein
said substrate having said light source is arranged to be opposed to a side of said light guide plate, and
said pressing portion is formed to press said mounting surface of said substrate arranged to be opposed to said side of said light guide plate toward said heat radiation portion.

12. The illuminator for a display according to claim 1, wherein
said light source includes a light-emitting device.

13. The illuminator for a display according to claim 1, further comprising a rear chassis, made of a metal, arranged to cover a back surface of said light guide plate, wherein
said heat radiation portion is integrally provided on said rear chassis.

14. The illuminator for a display according to claim 1, wherein
said substrate is mounted on said heat radiation portion through a heat radiation tape having viscosity.

15. A display comprising:
a display portion; and
an illuminator for a display, wherein
said illuminator for a display includes a substrate having a mounting surface mounted with a light source, a light guide plate including a light guide plate body portion guiding light received from said light source to said display portion, a heat radiation portion arranged on a side of said substrate opposite to said mounting surface for radiating heat generated by said light source, and a pressing portion pressed by said light guide plate body portion thereby pressing said mounting surface of said substrate toward said heat radiation portion.

16. The display according to claim 15, wherein
a plurality of said light sources are provided on said mounting surface of said substrate at a constant interval, and
said pressing portion is formed to press said mounting surface of said substrate toward said heat radiation portion between said plurality of light sources arranged on said mounting surface of said substrate at said constant interval.

17. The display according to claim 15, wherein
said pressing portion is integrally provided on said light guide plate body portion to protrude toward said substrate.

18. The display according to claim 15, wherein
said pressing portion is arranged between said mounting surface of said substrate and said light guide plate body portion, consists of an elastically deformable member, and is formed to be pressed by said light guide plate body portion thereby pressing said mounting surface of said substrate toward said heat radiation portion.

19. The display according to claim 18, wherein
said pressing portion is formed to come into direct contact with either said light guide plate body portion or said mounting surface of said substrate in a state bonded to either said mounting surface of said substrate or said light guide plate body portion through a bonding layer and to be pressed by said light guide body portion thereby pressing said mounting surface of said substrate toward said heat radiation portion.

20. The display according to claim 15, wherein
said pressing portion is formed to press said mounting surface of said substrate toward said heat radiation portion in a state in surface contact with said mounting surface of said substrate.
